(19) United States
(12) Patent Application Publication
(10) Pub. No.: US 2018/0034332 A1
(43) Pub. Date: Feb. 1, 2018

(54) ROTARY ELECTRIC MACHINE

(71) Applicant: DENSO CORPORATION, Kariya-city, Aichi-pref. (JP)

(72) Inventor: Yuki TAKAHASHI, Kariya-city (JP)

(73) Assignee: DENSO CORPORATION, Kariya-city, Aichi-pref. (JP)

(21) Appl. No.: 15/552,213

(22) PCT Filed: Jan. 28, 2016
(86) PCT No.: PCT/JP2016/052429

§ 371 Date: Aug. 18, 2017

(30) Foreign Application Priority Data
Feb. 18, 2015 (JP) 2015-029675

(51) Int. Cl. H02K 3/28; H02K 3/32; H02K 3/12; H02K 9/19; H02K 1/27; H02K 1/16

(52) U.S. Cl. CPC H02K 3/28; H02K 1/276; H02K 1/16; H02K 3/12; H02K 9/19; H02K 3/32

(57) ABSTRACT

A rotary electric machine includes a rotor having a plurality of magnetic poles and a stator having a core and coil, the core including slots and the coil being formed of phase windings of three phases wound in the core. A slot multiple n is set to 2, each windings of the coil being wound as short windings extending over (n+1) adjacent slots. With the axis of rotation of the rotor as center, designating α as the arc ratio of a magnetic pole, β as the circumferential-direction angular range of magnetic flux interchange faces of the rotor, which face the core and at which magnetic flux is interchanged with the core, and designating γ as a slot pitch of the slots in the circumferential direction, relationships β≦2nγ and β<α are established, to efficiently obtain magnetic flux flowing between the stator and the rotor.

### TECHNICAL FIELD

The present invention relates to a rotary electric machine installed in a vehicle or the like and is used as a motor or a generator.

### BACKGROUND ART

Conventionally, a rotary electric machine is typically known which is installed and used in a vehicle, and which includes a rotatably supported rotor provided with magnetic poles alternately differing in polarity in a circumferential direction, and a stator having a stator core and a stator coil, the stator core having a plurality of slots circumferentially arrayed and radially facing the rotor and the stator coil formed of phase windings of three phases wound as distributed windings in the slots of the core.

In Patent Literature 1 and Patent Literature 2, a stator core is disclosed in which respective pairs of slots that house windings of the same phase are consecutively provided in a circumferential direction, at each of the magnetic poles of the rotor, with the slot multiple being 2. Furthermore in Patent Literature 1, a stator coil is disclosed in which long windings and short windings are alternately wound along a circumferential direction of the stator core.

### CITATION LIST

### Patent Literature

[Patent Literature 1] JP-A-2014-96986

[Patent Literature 2] JP-A-11-285216

### SUMMARY OF THE INVENTION

### Technical Problem

To improve the performance of such a rotary electric machine, it is in general necessary to efficiently acquire a large flow of magnetic flux between the stator core and the rotor core. However in a case in which the slot multiple is increased or short windings are utilized, for reasons such as decreasing vibration or the like, then the overall amount of magnetic flux will be reduced. In addition, if the slot multiple of the stator coil is 2 or more, with distributed windings, and a number of slots are crossed by short windings, then if the arc ratio of each magnetic pole of the rotor is made large, a problem arises that demagnetizing fields will be produced within the same phase, so that a required amount of magnetic flux cannot be efficiently obtained.

The object of the present invention, in view of the above, is to solve the problem by providing a rotary electric machine in which the slot multiple of the stator is made 2 or more and the stator coil is wound with distributed windings and short windings, but in which a flow of magnetic flux between the stator and the rotor can be efficiently acquired.

### Solution to Problem

A rotary electric machine according to the first invention made to solve the above problem includes a rotor (30, 40) which has a plurality of magnetic poles arranged with polarities that alternate in a circumferential direction, and a stator (20) which has a stator core (22) having a plurality of slots (25) circumferentially arranged and radially facing the rotor, and which has a stator coil (21) housed in the slots and formed of phase windings of three phases that are wound as distributed windings in the stator core. A slot multiple of the slots in the stator core is set as n, with a proportion of n slots per one phase of the stator coil (where n is a natural number of 2 or more). Each of the phase windings of the stator coil is wound as a short winding extending over (n+1) adjacent ones of the slots. With an axis of rotation (O) of the rotor as center, designating α as an arc ratio of the magnetic pole, β as a circumferential-direction angular range of each magnetic flux interchange face (36, 46) of the rotor, which is positioned so as to face the stator core and at which magnetic flux is interchanged with the stator core, and γ as a slot pitch of the slots in the circumferential direction, relationships ⊖≦2nγ and β<α are established.

When defining a full winding as a winding which is wound with a slot pitch equal to a number obtained by dividing the number of slots of the stator by the number of magnetic poles of the rotor, the term short winding is used herein to signify a winding which is wound with a slot pitch that is less than that of the full winding.

According to the configuration, when, with the axis of rotation of the rotor as center, α is the arc ratio of a magnetic pole, β is the circumferential-direction angular range of a magnetic flux interchange face of the rotor core, which faces the stator core and at which magnetic flux is interchanged with the stator core, γ is the slot pitch of the slots in the circumferential direction, and the slot multiple is n, relationships β≦2nγ and β<α are established. That is, according to the first invention, due to the relationship β<α, a greater amount of magnetic flux is produced in the range of the arc ratio α of a magnetic pole than the amount set by the circumferential-direction angular range β of the magnetic flux interchange face, i.e., with that magnetic flux passing into the slots through the magnetic flux interchange face having the circumferential-direction angular range β which is smaller than the arc ratio α of the magnetic pole. At that time, since the circumferential-direction angular range β of the magnetic flux interchange face is set as β≦2nγ, and each of the phase windings of the stator core is wound as short windings extending over (n+1) adjacent slots, demagnetizing fields are not produced in windings of the same phase, even when the phase windings are connected in series or in parallel. That is, the circumferential-direction angular range β of the magnetic flux interchange face of the rotor facing the stator is set as a range in which demagnetizing fields do not arise. Hence according to the present invention, magnetic flux flowing between the stator and the rotor can be efficiently acquired.

A rotary electric machine according to the second invention made to solve the above problem includes a rotor (30, 40) which has a plurality of magnetic poles arranged with polarities that alternate in a circumferential direction, and a stator (20) which has a stator core (22) having a plurality of slots (25) circumferentially arranged and radially facing the rotor, and which has a stator coil (21) housed in the slots and formed of phase windings of six phases that are wound as distributed windings in the stator core. A slot multiple of the slots in the stator core is set as n, with a proportion of n slots per one phase of the stator coil (where n is a natural number of 2 or more). Each of the phase windings of the stator coil is wound as a short winding extending over n adjacent ones of the slots. With an axis of rotation (O) of the rotor as center, designating α as an arc ratio of the magnetic pole, β as a circumferential-direction angular range of each magnetic flux interchange face (36, 46) of the rotor, which is positioned so as to face the stator core and at which magnetic flux is interchanged with the stator core, and γ as a slot pitch of the slots in the circumferential direction, relationships β≦(3n−1)γ and β<α are established.

According to the configuration, with the axis of rotation of the rotor as center, when α is the arc ratio of the magnetic pole, β is the circumferential-direction angular range of the magnetic flux interchange face of the rotor core, which faces the stator core and at which magnetic flux is interchanged with the stator core, and γ is the slot pitch of the slots in the circumferential direction, and the slot multiple is n, relationships β≦(3n−1)γ and β<α are established. That is, according to the second invention, the circumferential-direction angular range β of the magnetic flux interchange face of the rotor core is set based on the relationship β≦(3n−1)γ to a range in which demagnetizing fields do not arise. Due to the relationship β<α, a greater amount of magnetic flux is produced in the range of the arc ratio α of the magnetic pole than the amount set by the circumferential-direction angular range β of the magnetic flux interchange face. Hence, since each of the phase windings of the stator coil is wound as short windings extending over (n+1) adjacent slots, demagnetizing fields are not produced even when the phase windings are connected in series or in parallel, and hence magnetic flux can be efficiently acquired.

The signs shown in parentheses after members and parts in Solution to Problem and Claims indicate a relationship between them and specific members and parts in the embodiments described later and do not at all effect the configurations of the claims.

### BRIEF DESCRIPTION OF THE DRAWINGS

FIG. 1 is a schematic cross-sectional view of a rotary electric machine according to a first embodiment, taken along an axial direction;

FIG. 2 is a partial plan view of a two-pole portion showing the arrangement state of a stator and a rotor of the first embodiment;

FIG. 3 is a cross-sectional view of a conductor segment used in the first embodiment;

FIG. 4 is an explanatory diagram for illustrating a manner of inserting the conductor segments into slots of a stator core;

FIG. 5 is a schematic perspective view showing a set of large/small conductor segments used in the first embodiment;

FIG. 6 is a partial plan view showing part of the stator according to the first embodiment;

FIG. 7 is a perspective view showing part of a joint-side end portion of the stator according to the first embodiment;

FIG. 8 is a schematic explanatory diagram of the arrangement of the conductor segments housed in the slots of the stator core of the first embodiment, viewed from the joint-side end portion side;

FIG. 9 is a partial plan view showing a single magnetic pole portion of a rotor according to a first modification;

FIG. 10 is a partial plan view showing a single magnetic pole portion of a rotor according to a second modification;

FIG. 11 is a partial plan view showing a single magnetic pole portion of a rotor according to a third modification;

FIG. 12 is a perspective view of a rotor core according to a fourth modification;

FIG. 13 is a partial cross-sectional view of the rotor core according to the fourth modification taken along an axial right-angle direction;

FIG. 14 is a partial cross-sectional view of a rotor core according to a fifth modification taken along an axial right-angle direction;

FIG. 15 is a partial cross-sectional view of a rotor core according to a sixth modification taken along an axial right-angle direction;

FIG. 16 is a partial plan view of a double magnetic pole portion showing the arrangement of the stator and the rotor according to a seventh modification;

FIG. 17 is a schematic cross-sectional view of a rotary electric machine according to a second embodiment, taken along an axial direction;

FIG. 18 is a plan view of a first pole core of a rotor core and a stator core according to the second embodiment, seen in the axial direction thereof;

FIG. 19 is a partial plan view of a single magnetic pole portion, showing the arrangement of the stator and rotor of the second embodiment;

FIG. 20 is a perspective view of the first pole core of the rotor core according to the second embodiment;

FIG. 21 is a perspective view showing an assembled state of the first pole core and a second pole core of the rotor core according to the second embodiment;

FIG. 22 is a partial plan view of a single magnetic pole portion, showing the arrangement of a stator and a rotor of an eighth modification;

FIG. 23 is a cross-sectional view of a rotor according to a ninth modification taken along an axial direction thereof;

FIG. 24 is a schematic cross-sectional view taken along an axial direction of a rotary electric machine according to a tenth modification;

FIG. 25 is a partial plan view showing a double magnetic pole portion showing the arrangement of a stator and a rotor of a third embodiment.

FIG. 26 is a partial plan view of a double magnetic pole portion showing the arrangement of a stator and a rotor of an eleventh modification;

FIG. 27 is a partial plan view of a single magnetic pole portion showing the arrangement of a stator and a rotor of a fourth embodiment;

FIG. 28 is a partial plan view of a single magnetic pole portion showing the arrangement of a stator and a rotor of a twelfth modification.

### DESCRIPTION OF THE EMBODIMENTS

Hereinafter, embodiments of a rotary electric machine according to the present invention are described in detail with reference to the drawings.

### First Embodiment

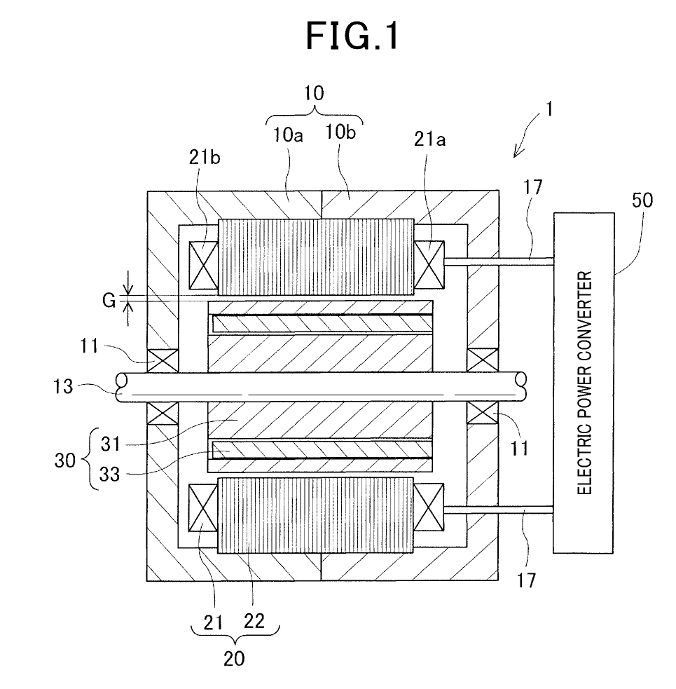

As shown in FIG. 1, a rotary electric machine 1 of the first embodiment is a motor generator for a vehicle, and includes a housing 10, a stator 20 which functions as an armature and has a stator core 22 and a stator coil 21, a rotor 30 which has a plurality of embedded permanent magnets forming magnetic poles whose polarities are alternately changed in the circumferential direction to act as field magnets, and an electric power converter 50. The electric power converter 50 is connected to the stator coil 21 by input/output lines 17 or the like. The housing 10 is formed with a substantially cylindrical shape by joining apertures of a pair of housing members 10a and 10b having a bottomed cylindrical shape in which one end of the cylinder opens.

The stator 20 includes the stator core 22 having a plurality of slots 25 formed in a cylindrical shape and arranged in the circumferential direction, a segment-type stator coil 21 that is formed of a plurality of conductor segments (wires) 23, and an insulation sheet member 24 providing electrical insulation between the stator core 22 and the stator coil 21. The stator 20 is fixed to the housing 10 by holding an external circumferential portion of the stator core 22 between the pair of housing members 10a and 10b (see FIG. 1).

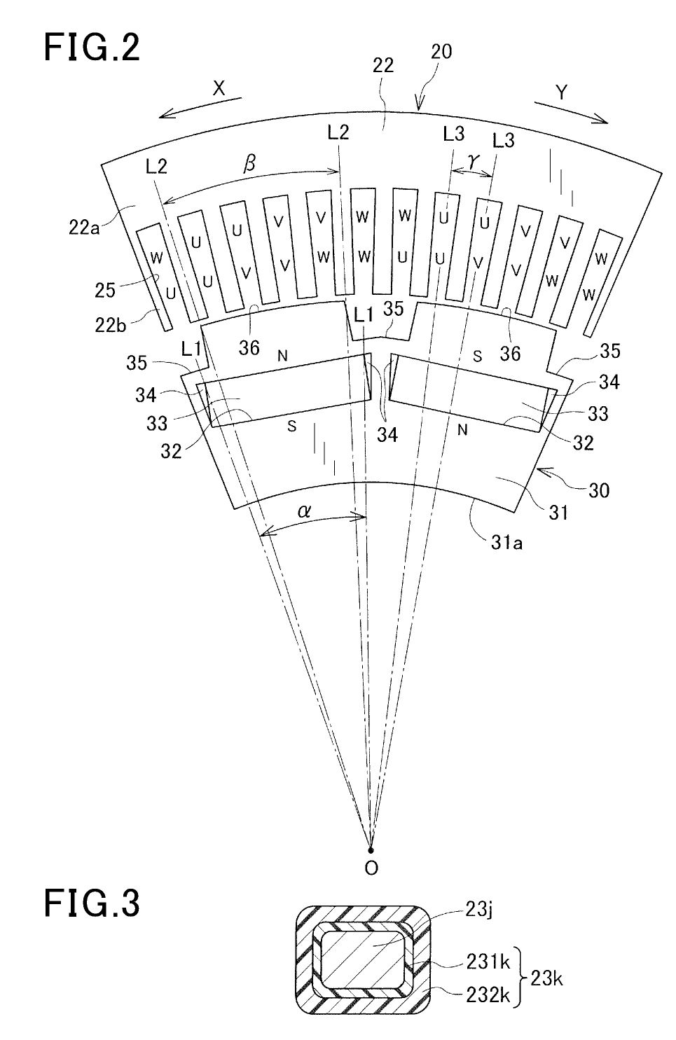

The stator core 22 is integrally formed by stacking a plurality of cylindrical-shaped magnetic steel sheets along an axial direction. As shown in FIG. 2, the stator core 22 is made up of a cylindrical-shaped back core 22a constituting an external circumferential portion and a plurality of teeth 22b which project radially inward from the back core 22a and are arrayed circumferentially, separated by a predetermined distance. The slots 25 penetrate in an axial direction and are formed circumferentially at equal distance so as to house the stator coil 21 that is wound in the stator core 22, with each of the slots 25 being formed between an adjacent pair of the teeth 22b of the stator core 22. In the first embodiment, mutually opposed surfaces (circumferential-direction side faces) of two adjacent teeth 22b of one slot 25, which partition the both sides of the slot 25 positioned in the circumferential direction, are made parallel to each another. Hence, each of the teeth 22b is formed so as to be slightly tapered towards the tip at the radially inward end of the tooth.

The number of slots 25 is set corresponding to the number of magnetic poles of the rotor 30 (16 poles, in the case of the first embodiment) such that there is a ratio of n slots 25 (where n is a natural number of 2 or more) per one phase of the stator coil 21, with the slot multiple being made 2. Hence, in the first embodiment, the number of slots 25 is 16×3×2=96. In addition, the slot pitch γ of the slots 25 in the circumferential direction around the axis of rotation O of the rotor 30 is 360°/96=3.75°. The slot pitch γ is defined as the angle between two straight lines L3 and L3 which respectively connect the circumferential-direction centers of the slots 25 and the axis of rotation O. Since the slots 25 and the teeth 22b are formed circumferentially at equal intervals, the slot pitch γ is equal to the pitch of the teeth 22b in the circumferential direction.

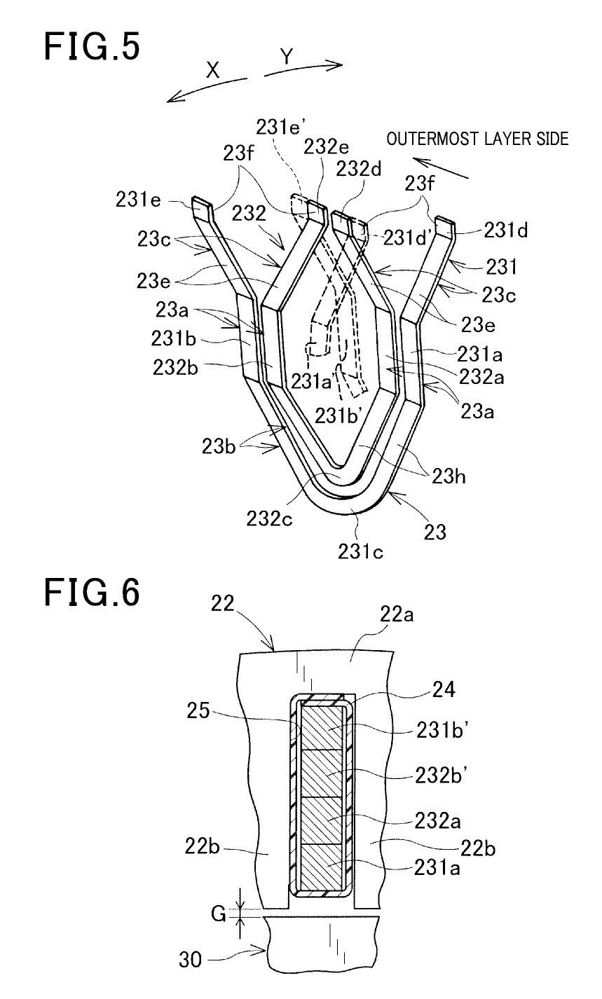

The stator coil 21 that is wound in the slots 25 of the stator core 22 consists of three phase windings which are formed as distributed windings. The stator coil 21 consists of a plurality of U-shaped conductor segments 23 whose joint end portions 23f (see FIG. 5) are joined to each other. As shown in FIG. 3, the conductor segment 23 is formed of a rectangular member that consists of a conductor portion 23j having a rectangular cross section and formed of an electrically conductive metal material such as copper or aluminum, and an electrical insulation film 23k which covers the outer periphery surface of a conductor portion 23j and is formed as a two-layer structure consisting of an inner layer 231k and an outer layer 232k. It is noted that, at the joint end portions 23f, the electrical insulation film 23k is removed so that the conductor portion 23j thereinside is exposed, and after the predetermined joint end portions 23f of the different conductor segments 23 have been connected to each other, electrical insulation processing is applied.

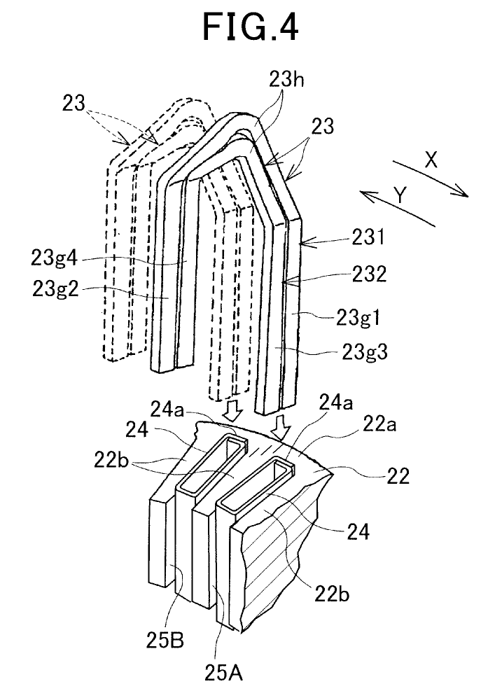

As shown in FIG. 4, the conductor segment 23 has a U shape with a pair of linear portions 23g, 23g and a turn portion 23h which links respective end portions of the linear portions 23g, 23g. In FIG. 4, a set of two of conductor segments 23 (large segment 231 and small segment 232) is shown which are respectively inserted in two adjoining slots 25A and 25B. In this case, the pairs of linear portions (23g1, 23g2) (23g3, 23g4) of the pair of large and small segments 231, 232 are respectively inserted into two slots 25A, 25C which are separated from each another by 5 slot pitches (see FIG. 8), being inserted from one end of each slot and along the axial direction (the direction from the rear side of the paper as seen in FIG. 2, from the upper side as seen in FIG. 4).

That is, one straight line portion 23g1 of the large segment 231 is inserted into the fourth layer (outermost layer) of one slot 25A, while the other straight line portion 23g2 of the large segment 231 is inserted into the first layer (innermost layer) of another slot (not shown) which is separated from slot 25A by 5 slot pitches in the counterclockwise direction of the stator core 22 (the Y arrow direction in FIGS. 2 and 4). Then, one linear portion 23g3 of the small segment 232 is inserted into the third layer of one slot 25A, while the other linear portion 23g4 of the small segment 232 is inserted into the second layer of the other slot (not shown) which is separated by 5 slot pitches in the counterclockwise direction of the stator core 22. In this way, the linear portions 23g of an even number of conductor segments 23 are arranged and inserted into all of the slots 25. In the first embodiment, a total of 4 linear portions 23g1 to 23g4 are disposed radially in a single row, in each slot 25.

As shown in FIG. 5, the open end portions of the linear portions 23g1 to 23g4 of the large and small segments 231, 232, which are inserted into each slot 25 from one axial-direction end side in the above manner, extend from the slot 25 to the other axial-direction end side (upper end side in FIG. 5). The open end portions of the pairs of linear portions (23g1, 23g2) (23g3, 23g4) of the large and small segments 231, 232 are mutually skewed in the circumferential counterclockwise direction so as to incline with respect to the end face of the stator core 22 positioned in the axial direction at a predetermined angle, forming oblique portions 23e each having a length of approximately 2.5 slot pitches.

As shown in FIG. 5, a paired set of large/small segments 231, 232 has pairs of slot-housed portions 23a, 23a that are housed within slots 25 and extend linearly along an axial direction, and coil end portions which extend outward in circumferential directions from the slots 25. A coil end portion consists of a turn-side end portion 23b which is integrally formed of slot-housed portions 23a, 23a so as to link end portions of the slot-housed portions 23a, 23a and which projects from one axial-direction end side of a slot 25 (at the rear side of the rotary electric machine 1, the right-hand side as viewed in FIG. 1), and a pair of joint-side end portions 23c, 23c which are formed integrally with the respective other ends of the slot-housed portions 23a , 23 and project from the other axial-direction end side of the slot 25 (at the front side of the rotary electric machine 1, the left-hand side as viewed in FIG. 1).

The turn-side end portion 23b has an approximately V-shaped turn portion 23h formed by curved deformation of the tip of the turn-side end portion 23b. A joint-side end portion 23c has oblique portions 23e and joint end portions 23f, where the oblique portion 23e is twisted in the circumferential direction, being skewed diagonally at a predetermined angle with respect to the axial-direction end face of the stator core 22, and the joint end portion 23f is formed integrally with the tip of the oblique portion 23e by bending deformation.

Each of the slots 25 of the stator core 22 houses an even number (in the present embodiment, 4) of electrical conductors (the slot-housed portion 23a of respective conductor segments 23). As shown in FIG. 6, the four electrical conductors that are housed in a single slot 25 are arranged as a single low, in order of first layer, second layer, third layer, and fourth layer from the inner circumferential side of the stator core 22. The stator coil 21 is formed by connecting the electrical conductors housed within the slots 25 in a specific pattern.

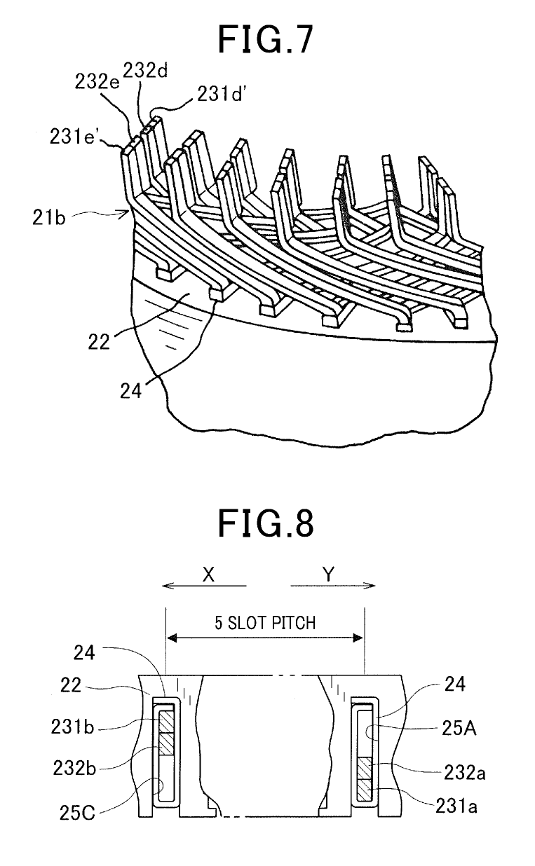

The turn-side end portions 23b at one axial-direction end side of the stator core 22 (the lower side, in FIG. 5) of the electrical conductors within each of the slots 25 are electrically connected via turn portions 23h. First coil end portions are thereby formed by a plurality of turn portions 23h which project from the slots 25, at one axial-direction end side of the stator core 22. In addition, the joint-side end portions 23c at the other axial-direction end of the stator core 22 (the upper side, in FIG. 5) are electrically connected by joining joint end portions 23f by means such as welding. Thus, second coil end portions 21b are formed (see FIG. 7) by a number of joint-side end portions 23c which project from the slots 25 at the other axial-direction end side of the stator core 22.

One electrical conductor (slot-housed portion 23a) within each slot 25 is paired with a single electrical conductor (slot-housed portion 23a) within another slot 25 that is separated by five slot pitches. For example, as shown in FIG. 8, an electrical conductor 213a that is housed in the first layer in one slot 25A is paired with an electrical conductor 213b that is housed in the fourth layer in the other slot 25C which is separated by five slot pitches in the clockwise rotation direction around the stator core 22 (the X-direction indicated by an arrow in FIGS. 4, 5 and 8). Similarly, an electrical conductor 232a that is housed in the second layer in one slot 25A is paired with an electrical conductor 232b that is housed in the third layer in the other slot 25C separated by five slot pitches in the clockwise rotation direction (X direction indicated by the arrow) around the stator core 22.

At a turn-side end portion 23b at one axial-direction end side of the stator core 22, the electrical conductors that are paired, that is, the electrical conductor 213a that is in the first layer and the electrical conductor 213b that is in the fourth layer are connected via a turn portion 23h (231c). In addition, the electrical conductor 232a that is in the second layer and the electrical conductor 232b that is in the third layer are connected via a turn portion 23h (232c).

That is, at the turn-side end portions 23b, an electrical conductor 231a that is in the first layer and an electrical conductor 232a that is in the second layer, which are housed within one slot 25, extend from the slot 25 in the clockwise direction (X direction indicated by the arrow) of the stator core 22. In addition, an electrical conductor 231b that is in the fourth layer and an electrical conductor 232b that is in the third layer, which are housed within one slot 25, extend from the slot 25 in the counterclockwise direction (Y direction indicated by the arrow in FIGS. 4, 5 and 8) of the stator core 22.

In addition, an electrical conductor 232a that is in the second layer of one slot 25 is paired with an electrical conductor 231a′ that is in the first layer of another slot 25, which is separated by 5 slot pitches in the clockwise direction (X direction indicated by the arrow) around the stator core 22. The pair of the electrical conductor 232a in the second layer and the electrical conductor 231a′ in the first layer is connected by the joining of joint end portions 23f (232d and 231d′) of the joint-side end portion 23c at the other axial-direction end side of the stator core 22 (see FIG. 5).

Similarly, the electrical conductor 231b′ that is in the fourth layer of one slot 25 is paired with an electrical conductor 232b that is in the third layer of another slot 25 that is separated by 5 slot pitches in the clockwise direction (X direction indicated by the arrow) around the stator core 22. That pair of the electrical conductor 231b′ is in the fourth layer and the electrical conductor 232b is in the third layer are connected by the joining of joint end portions 23f (231e′ and 232e) of the joint-side end portion 23c at the other axial-direction end side of the stator core 22 (see FIG. 5).

That is, at the joint-side end portion 23c, the electrical conductor 213a in the first layer and the electrical conductor 232b′ in the third layer, which are housed in one slot 25, extend from that slot 25 in the counterclockwise direction of the stator core 22 (Y direction indicated by the arrow). In addition, the electrical conductor 232a in the second layer and the electrical conductor 231b′ in the fourth layer, which are housed in one slot 25, extend from that slot 25 in the clockwise direction of the stator core 22 (X direction indicated by the arrow).

In this way, at the joint-side end portions 23c at the other axial-direction end side of the stator core 22, predetermined joint end portions 23f of the electrical conductors 23 are joined to each other by welding or the like. As a result, by connecting the predetermined conductor segments 23 in series, the stator coil 21 is formed of three phase windings (U-phase, V-phase, W-phase) that are wave-wound circumferentially along the slots 25 of the stator core 22. In this case, each phase winding of the stator coil 21 is wound as short windings of 5 slot pitches across n+1 adjacent slots 25 (3 slots in the case of the first embodiment, with n=2).

That is, in each phase winding, as shown in FIG. 2, two electrical conductors housed at the inner circumferential side in the slot 25 (in the first layer and in the second layer) are connected to two electrical conductors that are housed (in the third layer and in the fourth layer) at the outer circumferential side in the slot 25 that is separated by 5 slot pitches in the clockwise direction (X direction indicated by the arrow) of the stator core 22. Thus, in the first embodiment, the slot multiple n is 2, and hence, the slots 25 that house phase windings of the same phase in the first layer and the second layer at the inner circumferential side and also in the third layer and fourth layer at the outer circumferential side successively differ in circumferential position by one slot pitch.

Specifically as shown in FIG. 2, at the inner circumferential side at which the first layer and the second layer are housed, the slots 25 that house U-phase windings in the first and second layers, the slots 25 that house V-phase windings in the first and second layers, and the slots 25 that house W-phase windings in the first and second layers are each arranged so as to successively occur two at a time in repeated sequence, in the counterclockwise direction (Y direction indicated by the arrow) around the stator core 22. In addition, at the outer circumferential side at which the third layer and the fourth layer are housed, the slots 25 that house U-phase windings in the third and fourth layers, the slots 25 that house V-phase windings in the third and fourth layers, and the slots 25 that house W-phase windings in the third and fourth layers are arranged so as to successively occur two at a time in sequence in the counterclockwise direction (Y direction indicated by the arrow) around the stator core 22 in the state of one slot pitch displacement. As a result, each of the phase windings is wound over (n+1) adjacent slots 25 (3 slots, when n=2) of stator core 22.

It is noted that in the stator coil 21 of the first embodiment, due to the conductor segments 23 having a basically U-shaped form, each of the phase windings turns four times around the circumference of the stator core 22, and is formed with irregular segments (not shown in the drawings) having a different shape from that of the basic conductor segment 23. The irregular segments are segments that are integrally formed with output power lead-out wires or with neutral point lead-out wires, and segments having turn portions for respectively connecting the first and second circumferential turns, for connecting the second and third circumferential turns, and for connecting the third and fourth circumferential turns. The phase windings of the stator coil 21 are wired with star-formation wiring by using these irregular segments.

As shown in FIG. 1, the rotor 30 rotates integrally with the shaft 13, which is rotatably supported at both ends by bearings 11 in the housing 10, and is disposed coaxial with the stator core 22 in the housing 10, radially facing the stator core 22 and separated from the stator core 22 by a specific air gap G. The rotor 30 consists of a rotor core 31 having a plurality of magnet housing portions 32 arranged in the circumferential direction, with the rotor core 31 being disposed coaxial with the stator core 22, radially facing the stator core 22, and separated from the stator core 22 by the specific air gap G, and a plurality of permanent magnets 33 which are housed in the magnet housing portions 32 and form magnetic poles that successively alternate in polarity in the circumferential direction.

The rotor core 31 is formed with a thick-walled cylindrical shape by stacking a plurality of cylindrical steel sheets, each having a central through hole 31a, in the axial direction, and is fixed by engaging the outer periphery of the shaft 13 in the through hole 31a. The outer circumferential part of the rotor core 31 is provided with the plurality of magnet housing portions 32 (in the first embodiment, 16), which penetrate axially, arranged circumferentially at predetermined distances. The magnet housing portions 32 are trapezoidal in a cross-sectional shape, with the long side and the short side of the trapezoid at the outer periphery side and the inner periphery side, respectively, of the rotor core 31.

The permanent magnets 33 are embedded one by one in the magnet housing portions 32, with each permanent magnet 33 having a rectangular (oblong) cross-sectional shape. Thereby, a plurality of magnetic poles (in the first embodiment, 16 magnetic poles (8 N poles and 8 S poles) having successively alternating polarity are thereby formed around the external circumferential portion of the rotor core 31 by the permanent magnets 33 embedded in the magnet housing portions 32. Each permanent magnet 33 is formed such that the long side of the oblong cross-sectional shape of the permanent magnet 33 is slightly shorter than the short side of the trapezoidal cross-sectional shape of the magnet housing portion 32. As a result, magnetic gap portions 34, each having a triangular cross-sectional shape, are respectively formed at the circumferentially opposed sides of the permanent magnets 33 embedded in the magnet housing portions 32. In this case, the arc ratio α of each magnetic pole whose center is the axis of rotation (O) of the rotor 30 is defined as the angle between two straight lines L1, L1 which respectively connect the axis of rotation O and the circumferential-direction ends of the outer-side planar face of the permanent magnet 33 that is housed in the magnet housing portion 32.

The outer periphery surface of the rotor core 31 is formed of a plurality of recesses 35 which are recessed radially and inward and arranged circumferentially with predetermined separation spacings, and which are located at a circumferential position corresponding to the space between two circumferentially adjacent magnetic poles. Thereby, magnetic flux interchange faces 36 are thus formed between each of respective pairs of circumferentially adjacent recesses 35, at the outer periphery of the rotor core 31. The circumferential angular range β of the magnetic flux interchange face 36, which has the axis of rotation O of the rotor 30 as center, is defined as the angle between two straight lines L2, L2 which respectively connect the axis of rotation O and the circumferentially opposing sides of the magnetic flux interchange face 36.

In this case, the circumferential angular range β of the magnetic flux interchange face 36 is thereby made smaller than the arc ratio α of the magnetic pole, with the relationship β<α being established. Thus, due to the relationship β<α, the magnetic flux which flows between the stator 20 and the rotor 30 is increased relative to the magnetic flux that is set by the circumferential angular range β of the magnetic flux interchange face 36, in the range of the arc ratio α of the magnetic pole.

In addition, the circumferential angular range β of the magnetic flux interchange face 36 is set with respect to the slot multiple n and the slot pitch γ such that the relationship β≦2nγ is satisfied. Specifically, since n=2, γ=3.75°, the circumferential angular range β of the magnetic flux interchange face 36 is set as β≦2×2×3.75°=15°, being set as a range not exceeding 4 slot pitches of the inner periphery of the stator core 22. That is, the circumferential angular range β of the magnetic flux interchange face 36 is set so as to be equal to or less than the distance (4 slot pitches) between the two slots 25 housing electrical conductors (slot-housed portions 23a) of phase windings of the same phase, in which currents flow in mutually opposite directions. As a result, it is ensured that demagnetizing fields will not be produced by the phase windings of the same phase.

In the rotary electric machine 1 for vehicle of the first embodiment configured as described above, when the stator 20 is excited based on a drive current supplied from the electric power converter 50 and subjected to electric power conversion, rotational torque (which may become motive force) is generated by the action of the excitation, thereby rotating the rotor 30. In this case, the rotary electric machine 1 operates as a motor. The generated rotary torque is output from the rotor 30 and the shaft 13, for example, to a drive section which drives an axle shaft or the like.

In addition, when no power conversion signal is output by the electric power converter 50 and rotational force of an output shaft is transmitted to the shaft 13 by the action of the engine, then since the rotor 30 also rotates, counter-electromotive force is produced by the stator coil 21 of the stator 20. The generated counter-electromotive force (regenerated power) can charge a battery via the electric power converter 50. In this case, the rotary electric machine 1 operates as a generator.

As described above, according to the rotary electric machine 1 of the first embodiment, the slot multiple is set as n, each phase winding of the stator coil 21 is wound with short windings over (n+1) adjacent slots 25, and with the axis of rotation (O) of the rotor being the center, designating the arc ratio of the magnetic pole as α, the circumferential angular range of the magnetic flux interchange face 36 being β, and the slot pitch as γ, and the relationships β≦2nγ and β<α are satisfied. As a result, when magnetic flux flows between the stator 20 and the rotor 30, it is ensured that demagnetizing fields are not produced by the phase windings of the same phase of the stator core 21, so that a flow of magnetic flux between the stator 20 and the rotor 30 can be efficiently acquired.

In addition, according to the first embodiment, since recesses 35 which are recessed in the radial direction are formed at each of the circumferentially opposed sides of the magnetic flux interchange face of the rotor core 31, the circumferential angular range β (circumferential width) of the magnetic flux interchange face 36 can readily be set.

### First Modification

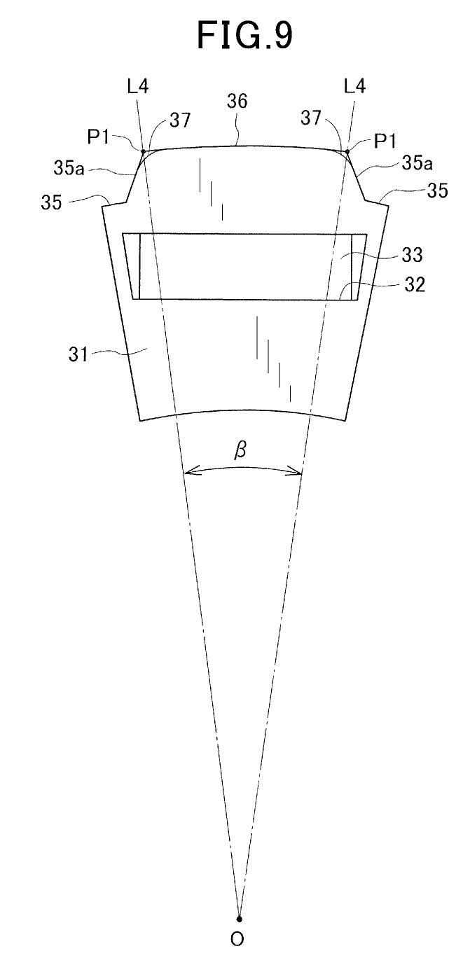

The rotor 30 of the first embodiment may be configured as shown in FIG. 9 for the rotor 30 of the first modification, in which an arc-shaped chamfer 37 is formed at each of the circumferentially opposing sides of the magnetic flux interchange face 36 of the rotor core 31, i.e., is formed on each corner of intersection between the magnetic flux interchange face 36 and a side face 35a of the recess 35, the side face 35a extending in radial and axial directions. In this case, the circumferential angular range β of the magnetic flux interchange face 36 is defined as the angle between two straight lines L4, L4 which connect the axis of rotation O of the rotor 30 and the intersection points P1, P1 at which a tangent to the magnetic flux interchange face 36 intersects with a tangent to the side face 35a of the recess 35. In addition, a flat C chamfer may be used, instead of an arc-shaped R chamfer.

### Second Modification

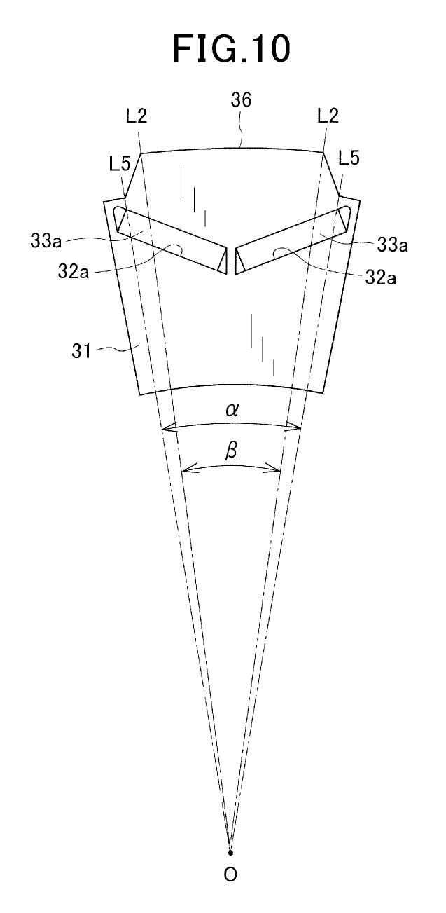

The rotor 30 of the first embodiment may be configured as shown in FIG. 10 for the second modification, in which the rotor core 31 has a plurality of pairs of magnet housing portions 32a arranged in a V formation such that the pair of magnet housing portions 32a are separated from each other as they approach the stator 20 side, and a plurality of pairs of permanent magnets 33a respectively housed in the pairs of magnet housing portions 32a arranged in a V formation to form a single magnetic pole.

In this case, the arc ratio α of a single magnetic pole formed by a pair of permanent magnets 33a is defined by the angle between two straight lines L5, L5 which connect the axis of rotation O of the rotor 30 to the corners positioned at the outermost periphery sides of the anti-magnetizing pole center sides of the permanent magnets 33a. It is noted that the circumferential angular range β of the magnetic flux interchange face 36 is the same as for the first embodiment. The second modification enables the magnetic force of each magnetic pole to be strengthened.

### Third Modification

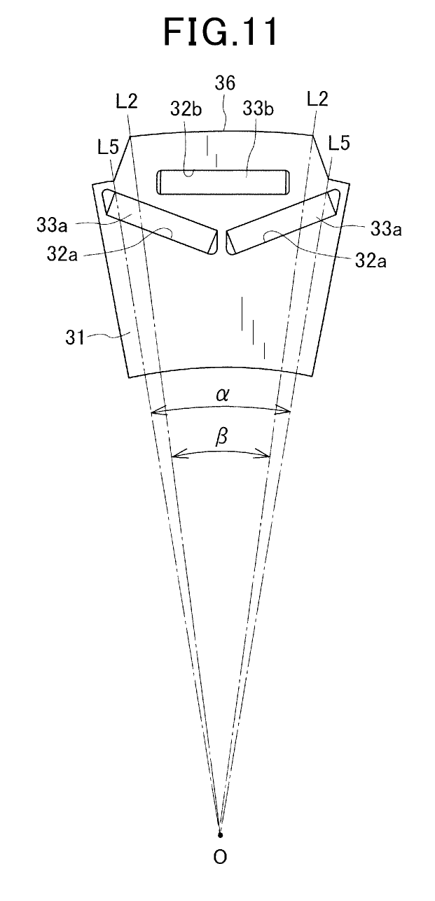

In the rotor 30 of the third modification, as shown in FIG. 11, for the rotor 30 of the second modification in which a single magnetic pole is formed of a pair of permanent magnets 33a, a permanent magnet 33b is further added to each magnetic pole. In this case, a magnet housing portion 32b having an oblong cross-sectional shape, whose long side extends in the circumferential direction, is disposed centrally at the outer periphery side of each pair of magnet housing portion 32a of the rotor core 31 that are arranged in the V formation, the permanent magnet 33b having an oblong cross-sectional shape being housed in the magnet housing portion 32b. In this case, the arc ratio α of each magnetic pole is similar to that of the second modification. The third modification enables the magnetic force of each magnetic pole to be further strengthened comparison with the second modification.

### Fourth Modification

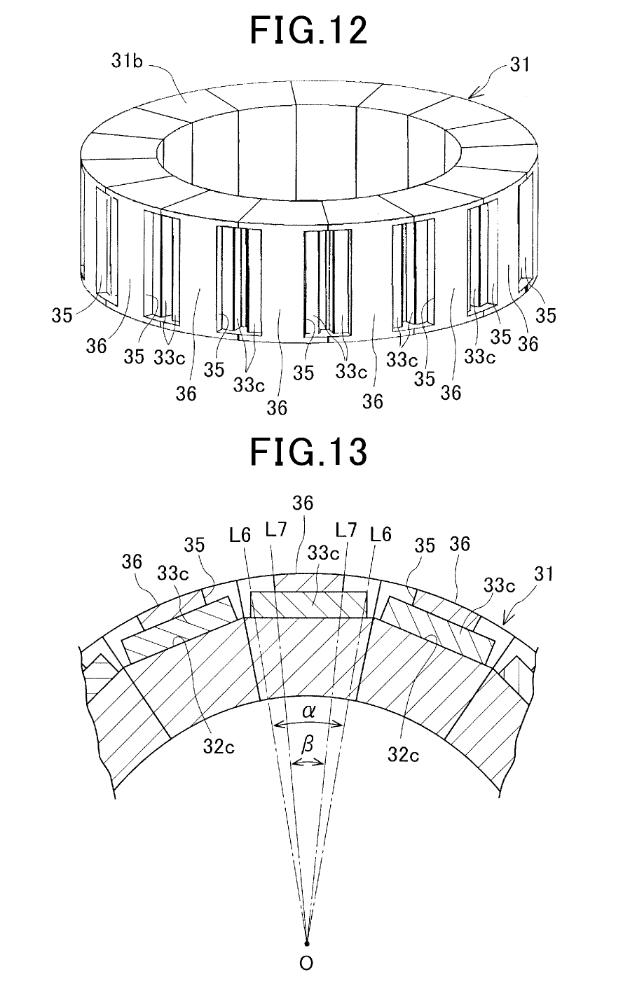

As shown in FIGS. 12 and 13, the rotor 30 of the fourth modification is made up of the rotor core 31 having a compressed-powder magnetic core formed by compressing and hardening powder of ferromagnet, and a plurality of permanent magnets 33c which are housed in magnet housing portions 32c formed in the rotor core 31 and constitute magnetic poles that alternate in polarity in the circumferential direction. The rotor core 31 is of a so-called cage type which is formed by assembling a plurality of partitioned cores 31b, which is divided in the circumferential positions, into a cylindrical shape.

In the rotor core 31, the magnet housing portions 32c are provided which have a predetermined radial-direction width and are formed in a cylindrical shape so as to make one complete turn in the circumferential direction, and which open at an end face of the rotor core 31 positioned at one axial-direction end side (the lower side in FIG. 12). A plurality of permanent magnets 33c having an oblong cross-sectional shape are arranged and housed in the magnet housing portions 32c, the permanent magnets 33c constituting a plurality of magnetic poles (in the fourth modification, 16 poles, i.e., 8 N poles and 8 S poles) which successively alternate in polarity in the circumferential direction. Each permanent magnet 33c is fixed in the rotor core 31 with an adhesive or the like. In this case, the arc ratio α of the magnetic pole whose center is the axis of rotation O of the rotor 30 is defined by the angle between two straight lines L6 and L6 which connect the axis of rotation O and the circumferentially opposing sides of the outer peripheral planar face of the magnet 33c.

The outer peripheral surface of the rotor core 31 is provided with a plurality of recesses 35 (in the fourth modification, 16) which are recessed radially and inward and are separated circumferentially at predetermined distances. As a result, the magnetic flux interchange face 36, through which magnetic flux is exchanged, is formed at the outer peripheral surface of the rotor core 31 and between the two adjacent recesses 35 so as to face the stator core 22. As in the case of the first embodiment, the circumferential angular range β of each of the magnetic flux interchange faces 36, whose center is the axis of rotation O of the rotor 30, is defined by the angle between two straight lines L7 and L7 which connect the axis of rotation O and the circumferentially opposing sides of the magnetic flux interchange face 36. It is noted that, also in the case of the fourth modification, the relationships between the arc ratio α of the magnetic pole and the circumferential angular range β of the magnetic flux interchange face 36 are set as in the case of the first embodiment so as to satisfy β≦2nγ and β<α.

### Fifth Modification

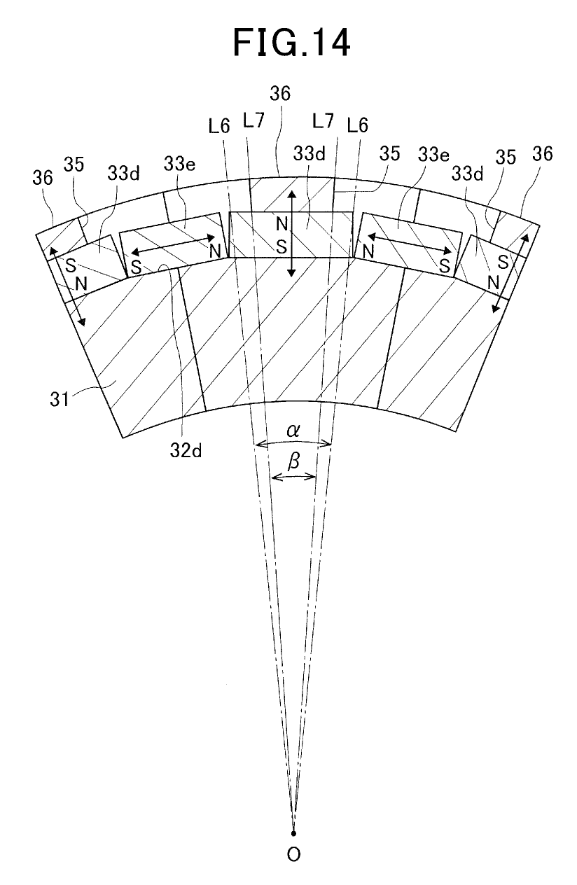

As shown in FIG. 14, the rotor 30 of the fifth modification has permanent magnets 33d, 33e arranged in a Halbach array in magnet housing portions 32d of the rotor core 31 having a cage shape formed as in the case of the fourth modification. In this case, the permanent magnets 33d, 33e are arranged so as to form magnetic poles whose polarities alternately differ in the circumferential direction, such that the permanent magnets 33d, 33e have two orientation directions, i.e., the circumferential direction and the radial direction. The permanent magnets 33d, 33e are fixed to the rotor core 31 with an adhesive or the like. It is noted that, also in the case of the fifth modification, the arc ratio α of the magnetic pole and the circumferential angular range β of the magnetic flux interchange face 36 are defined in the same manner as that in the fourth modification so as to satisfy the relationships β≦2nγ0 and β<aα.

In the case of the fifth modification, there are permanent magnets 33e which are arranged with their orientation directions in the circumferential direction, so that part of the magnetic force of these magnets is invalid. However, according to the fifth modification, the extent of the invalid magnetic force is reduced, so that it becomes possible to make full use of the characteristics of the permanent magnets 33e. As a result, the permeance is increased and resistance to heat is improved, together with the improvement in the obtained magnetic force.

### Sixth Modification

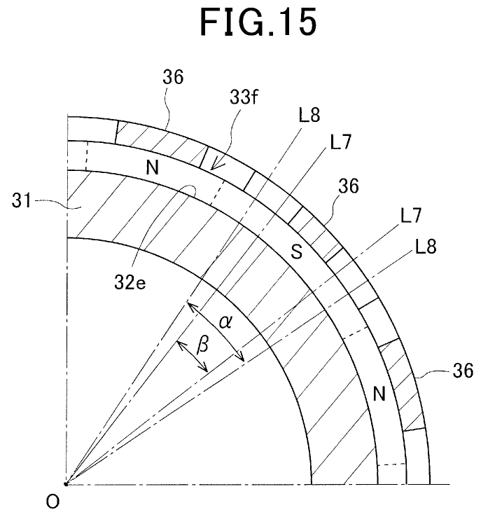

In the rotor 30 of a sixth modification, as shown in FIG. 15, an isotropic magnet having a cylindrical shape and magnetized with a plurality of circumferentially arrayed magnetic poles, is used as permanent magnets 33f embedded in the cage shaped rotor core 31, which is formed in the manner similar to that in the fourth modification. The isotropic magnet has a plurality of magnetic poles (in the sixth modification, 12 poles, i.e., 6 N poles and 6 S poles) formed with polarities that alternate in the circumferential direction. Hence, twelve recesses 35 and twelve magnetic flux interchange faces 36 are arranged at the outer peripheral surface of the rotor 30 so as to alternate in the circumferential direction.

In this case, the arc ratio α of each magnetic pole, whose center is the axis of rotation O of the rotor 30, is defined by the angle between two straight lines L8 and L8 which connect the axis of rotation O and the corners positioned at the outermost periphery sides at the anti-magnetizing pole center sides of each magnetic pole. Specifically, the arc ratio α is set as 6 slot pitches, which is 22.5°. The circumferential angular range β of each magnetic flux interchange face 36 is defined by the angle between two straight lines L7 and L7 as in the case of the fourth modification. It is noted that, also in the case of the sixth modification, the arc ratio α of the magnetic pole and the circumferential angular range β of the magnetic flux interchange face 36 are set so as to satisfy β≦2nγ and β<α as in the case of the first embodiment.

### Seventh Modification

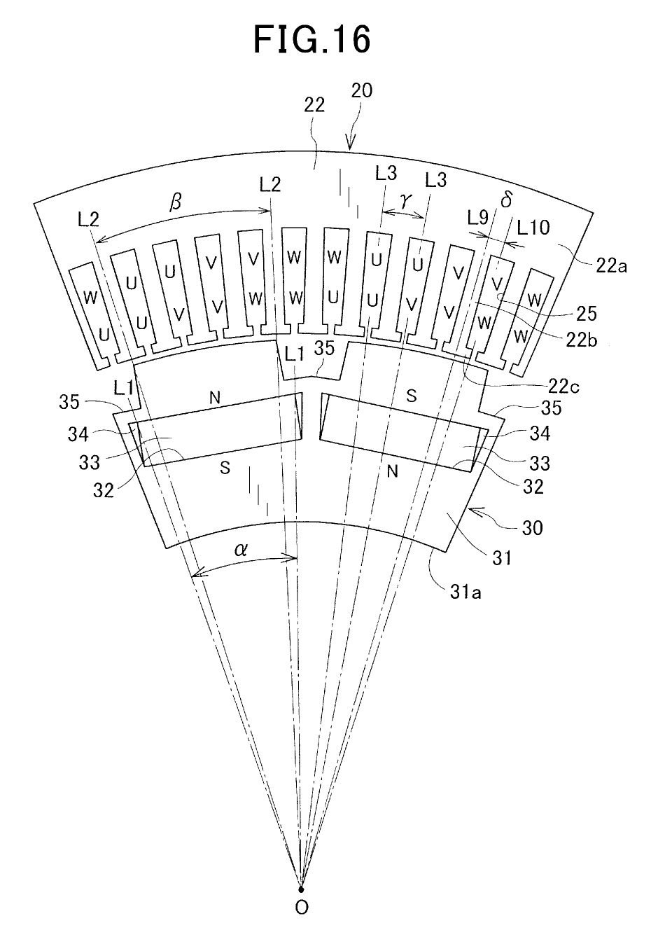

As shown in FIG. 16, the stator core 22 of the seventh modification differs from the stator core 22 of the first embodiment in that, in the seventh modification, the tip of each of the teeth 22b formed at the inner periphery of the stator core 22 has flange portions 22c which project to the circumferentially-opposed sides from the projecting tip of the tooth. In this case, when designating δ as the circumferential angular range, whose center is the axis of rotation O of the rotor 30, between the circumferential-direction center of a tooth 22b and the circumferential-direction tip of the flange portion 22c of the tooth 22b, the circumferential angular range β of the magnetic flux interchange face 36 is set as β≦2nγ−2δ. It is noted that the circumferential angular range δ is defined by the angle between a straight line L9 connecting the axis of rotation O and the circumferential-direction center of the tooth 22b and a straight line L10 connecting the axis of rotation O and a circumferential-direction tip of the flange portion 22c.

When each tooth 22b has the flange portions 22c at the projected tip, as in the seventh modification, the flow of magnetic flux between the stator 20 and the rotor 30 can be efficiently acquired by setting the circumferential angular range β of the magnetic flux interchange face 36 as the above-described range.

### Second Embodiment

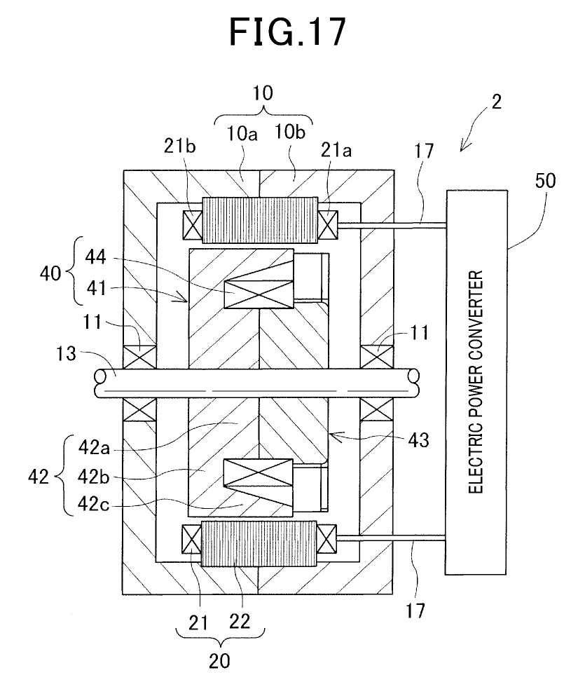

The rotary electric machine 2 of the second embodiment differs from the rotary electric machine 1 of the first embodiment, which uses an embedded permanent magnet type rotor 30, in that an electromagnet type rotor 40 having a Randle-type core 41 and a field coil 44 is used. Hence, the detailed descriptions of members and configurations that are common to the first embodiment are omitted in the following, in which points of difference and important points are described referring to FIGS. 17 to 21. It is noted that members that are common to the first embodiment are designated by identical reference numbers to those of the first embodiment.

The rotary electric machine 2 of the embodiment is a motor generator for a vehicle, and as shown in FIG. 17 includes a housing 10, a stator 20 functioning as an armature and having the stator core 22 and the stator coil 21, and a rotor 40 functioning as a field magnet and having a Randle-type core 41 and a field coil 44. The housing 10, the stator 20, and the electric power converter 50 of the second embodiment are as described in the first embodiment and shown in FIGS. 1 to 8, and detailed descriptions of these are omitted.

As shown in FIG. 17, the rotor 40 includes the shaft 13 which is rotatably supported at both ends by the bearings 11 in the housing 10, a Randle-type core 41, and a field coil 44 which is wound in the Randle-type core 41, with the Randle-type core 41 having a first pole core 42 at the front end and a second pole core 43 at the rear end, which are assembled along the axial direction.

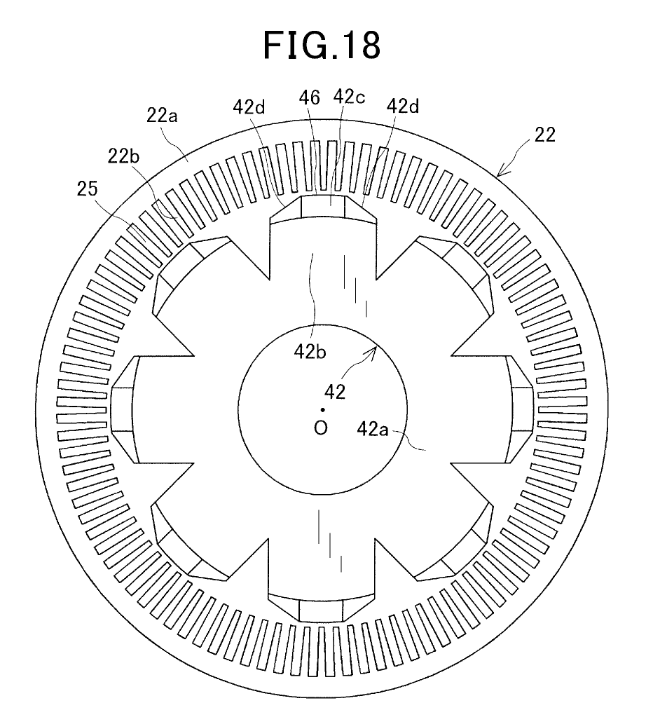

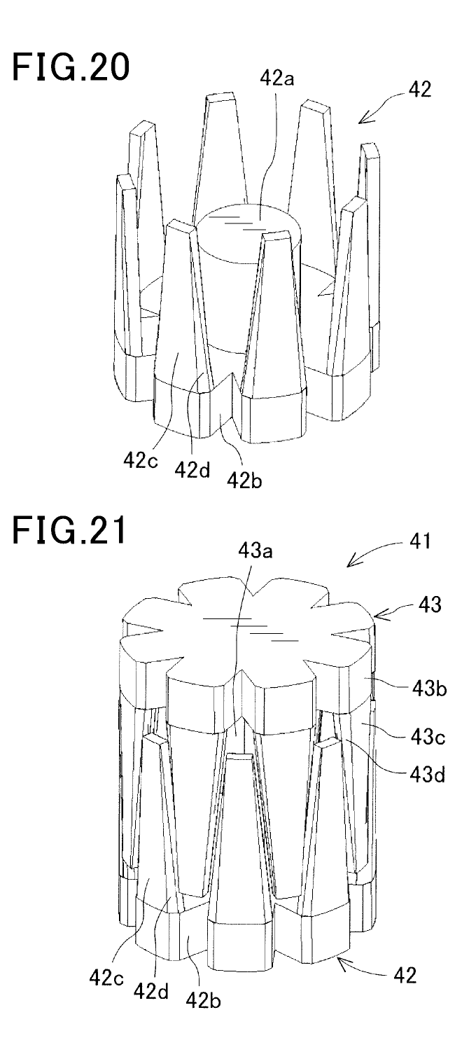

As shown in FIGS. 18 and 20, the first pole core 42 of the Randle-type core 41 is made up of a boss portion 42a which is of cylindrical shape and is fit to and fixed to the outer periphery of the shaft 13, a disc part 42b which extends radially from one axial-direction end of the boss portion 42a, and a plurality of (in the second embodiment, 8) first claw magnetic pole portions 42c extending from the outer periphery of the disc part 42b to the boss portion 42a side along the axial direction. As shown in FIGS. 17 and 21, the second pole core 43 is configured similarly to the first pole core 42, and is made up of a boss portion 43a, a disk portion 43b and eight second claw magnetic pole portions 43c.

The first pole core 42 and the second pole core 43 are assembled with their respective first claw magnetic pole portions 42c and second claw magnetic pole portions 43c facing each other, such that the respective axial-direction end faces of the boss portions 42a and 43a contact each another (see FIGS. 17 and 21). As a result, the first claw magnetic pole portions 42c and the second claw magnetic pole portions 43c are arranged alternately in the circumferential direction, with predetermined distances between them. The field coil 44 is formed by winding conductor wires in a cylindrical and coaxial form in a gap between the outer circumferences of the boss portions 42a, 43a and the first and second claw magnetic pole portions 42c, 43c, with the conductor wires having been treated with electrical insulation processing. The first claw magnetic pole portions 42c and the second claw magnetic pole portions 43c become magnetized with mutually opposite polarities when current is applied to the field coil 44. In the case of the second embodiment, there are 8 of each of the first and second claw magnetic pole portions 42c, 43c, so that a total of 16 magnetic poles (8 N poles, 8 S poles) are formed.

Each first claw magnetic pole portion 42c and second claw magnetic pole portion 43c is formed with a tapered shape, which gradually becomes narrower toward the tip end from the axial-direction base end (the side of a disk portion 42b or 43b). Flat chamfers 42d, 43d are formed at the corners of the intersections between the outer periphery surface and circumferentially opposing side faces of the first claw magnetic pole portion 42c and second claw magnetic pole portion 43c. A magnetic flux interchange face 46, which faces the stator core 22 and at which magnetic flux is interchanged with the stator core 22, is formed between the pair of circumferentially-opposed chamfers 42d, 43d of the first claw magnetic pole portion 42c and the second claw magnetic pole portion 43c.

The arc ratio α of each first claw magnetic pole portion 42c and second claw magnetic pole portion 43c, whose center is the axis of rotation O of the rotor 40, is defined as the angle between two straight lines L11 and L11 which connect the axis of rotation O and the corners at which the chamfers 42d and 43d intersect with the circumferentially-opposed side surfaces of the first claw magnetic pole portion 42c and the second claw magnetic pole portion 43c. In this case, due to the tapered shape of each first claw magnetic pole portion 42c and second claw magnetic pole portion 43c along the axial direction, the arc ratio α of the first claw magnetic pole portion 42c and second claw magnetic pole portion 43c varies along the axial direction, taking a maximum value αmax at the axial-direction base end.

The maximum angle αmax of the arc ratio α is set so as to satisfy the relationship between the slot multiple n and the slot pitch γ, of αmax≧3nγ. Specifically, with n=2, γ=3.75°, the maximum angle αmax of the arc ratio α is set as αmax≧3×2×3.75°=22.5°, being set within a range that is not less than 6 slot pitches at the inner periphery of the stator core 22.

In addition, the circumferential angular range β of the magnetic flux interchange face 46 of the first claw magnetic pole portion 42c and the second claw magnetic pole portion 43c is defined by the angle between two straight lines L12 and L12 which connect the axis of rotation O and the circumferentially opposed ends of the magnetic flux interchange face 46. In this case, the circumferential angular range β of the magnetic flux interchange face 46 is made smaller than the arc ratio α of the first claw magnetic pole portion 42c and the second claw magnetic pole portion 43c, with the relationship β<α being established. As a result, since β<α, the magnetic flux that flows between the stator 20 and the rotor 40 is made greater than the magnetic flux that is set by the circumferential angular range β of the magnetic flux interchange face 46 in the range of the arc ratio α of the first claw magnetic pole portion 42c and the second claw magnetic pole portion 43c.

In addition, the circumferential angular range β of the magnetic flux interchange face 46 is set such that the relationship with the slot multiple n and the slot pitch γ is established as β≦2nγ. Specifically, as in the case of the first embodiment, n=2 and γ=3.75°, and the circumferential angular range β of the magnetic flux interchange face 46 is set as β≦2×2×3.75°=15°, so that the circumferential angular range β of the magnetic flux interchange face 46 is within a range no greater than 4 slot pitches with respect to the inner periphery surface of the stator core 22. That is, the circumferential angular range β of the magnetic flux interchange face 46 is set to be no greater than the interval (4 slot pitches) between two slots 25 which house electrical conductors (slot-housed portions 23a) in which currents flow in mutually opposite directions in the phase windings of the same phase. As a result, demagnetizing fields are not produced in the phase windings of the same phase.

In the rotary electric machine 2 for a vehicle of the second embodiment configured as described above, when excitation is produced in the stator 20 based on a drive current obtained through electric power conversion and supplied from the electric power converter 50, rotational torque (which may become motive force) is produced by excitation action, and the rotor 40 rotates. In this case, the rotary electric machine 2 functions as a motor. The generated rotational torque is output from the rotor 40 and shaft 13, for example, to a drive section which drives an axle shaft or the like.

In addition, when a power conversion signal is not output by the electric power converter 50 and rotational force of an output shaft is transmitted to the shaft 13 by the operation of the engine, then since the rotor 40 also rotates, counter-electromotive force is produced by the stator coil 21 of the stator 20. The generated counter-electromotive force (regenerated power) can charge a battery via the electric power converter 50. In this case, the rotary electric machine 2 operates as a generator.

As described above, according to the rotary electric machine 2 of the second embodiment, the slot multiple is set as n, each phase winding of the stator coil 21 is wound with short windings over (n+1) adjacent slots 25, and with the axis of rotation (O) of the rotor being the center, designating the arc ratio of the first and second claw magnetic pole portions 42c, 43c as α, the circumferential angular range of the magnetic flux interchange face 36 being β, and the slot pitch as γ, the relationships β≦2nγ and β<α are satisfied, and the maximum angle of the arc ratio α, αmax, is set as αmax≧3nγ. As a result, when magnetic flux flows between the stator 20 and the rotor 40, it is ensured that demagnetizing fields are not be produced by the phase windings of the same phase of the stator coil 21, so that a flow of magnetic flux between the stator 20 and the rotor 40 can be efficiently acquired, so that the same actions and effects as those of the first embodiment can be obtained.

In addition, according to the second embodiment, since the electromagnet type rotor 40 having a Randle-type core 41 and a field coil 44 is utilized, compared with the embedded permanent magnet type rotor 30 of the first embodiment which has 2-dimensional planar faces that are continuous along the axial direction, the relationship β≧3n can be established near the end face of the stator core 22 positioned in the axial direction, so that increased magnetic force can be achieved.

### Eighth Modification

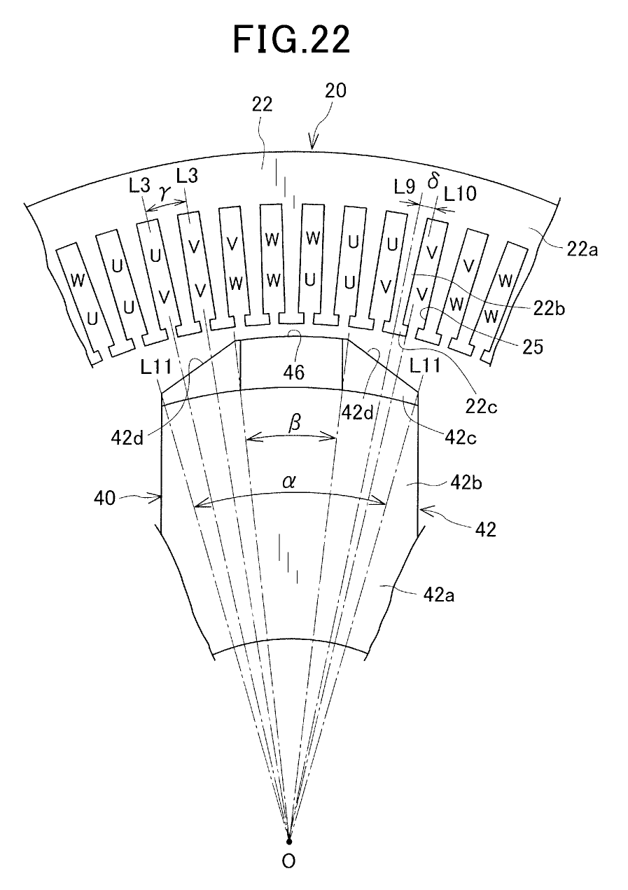

As shown in FIG. 22, as in the case of the seventh modification, the stator core 22 of the eighth modification differs from the stator core 22 of the second embodiment in that, in the eighth modification, the tip of each of the teeth 22b formed at the inner periphery of the stator core has flange portions 22c which project to the circumferentially-opposed sides from the projecting tip of the tooth. In this case, when designating δ as the circumferential angular range, whose center is the axis of rotation O of the rotor 30, between the circumferential-direction center of the tooth 22b and the circumferential-direction tip of the flange portion 22c of the tooth 22b, the circumferential angular range β of the magnetic flux interchange face 46 is set as β≦2nγ−2δ. It is noted that the circumferential angular range δ is defined by the angle between a straight line L9 connecting the axis of rotation O and the circumferential-direction center of the tooth 22b and a straight line L10 connecting the axis of rotation O and a circumferential-direction tip of the flange portion 22c.

When each tooth 22b has the flange portions 22c at the projected tip, as in the eighth modification, the flow of magnetic flux between the stator 20 and the rotor 40 can be efficiently acquired by setting the circumferential angular range β of the magnetic flux interchange face 46 as the above-described range.

### Ninth Modification

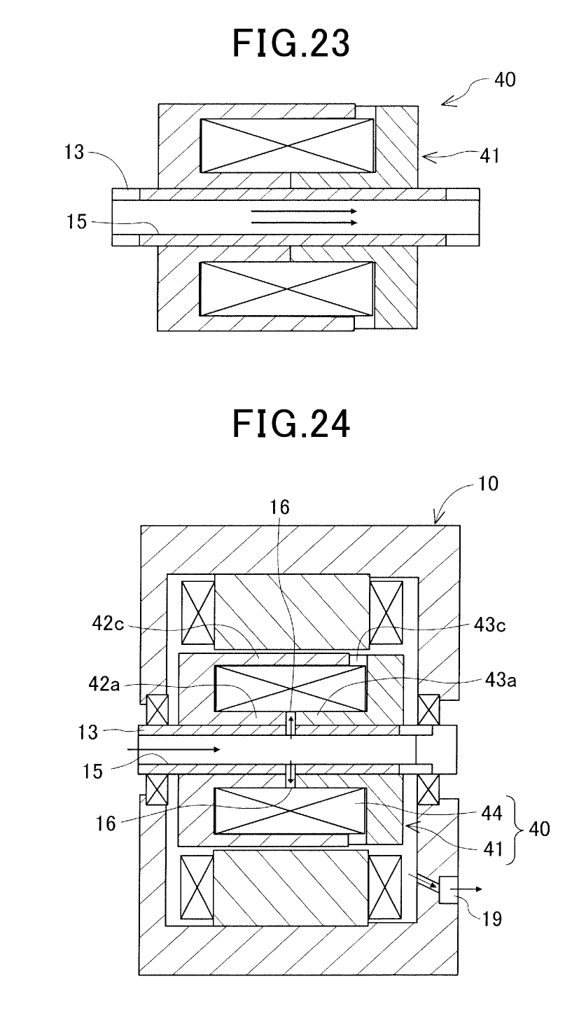

As shown in FIG. 23, the electromagnet type rotor 40 of the ninth modification has a Randle-type core 41 and a field coil 44 of the second embodiment, and has a first flow path 15 in the interior of the shaft 13, through which a liquid coolant flows in the axial direction. According to the ninth modification, by circulating the liquid coolant through the flow path 15 provided in the electromagnet type rotor 40, the field coil 44, which generates heat, can be intensively cooled.

### Tenth Modification

In the tenth modification, as shown in FIG. 24, a plurality of radially extending second flow paths 16 are added to the rotor 40 having the first flow path 15 of the ninth modification, with the second flow paths 16 being positioned at a central part of the shaft 13. The second flow paths 16 communicate at their radially inner sides with the first flow path 15, and the radially outer sides of the second flow paths 16 are open to each of the outer peripheries of the boss portions 42a, 43a of the first and second pole cores 42, 43 that form the Randle-type core 41. A drain hole 19 is provided in a lower part of the housing 10 to collect liquid coolant that has discharged from the second flow paths 16.

According to the tenth modification, the liquid coolant is passed from the first flow path 15 through the second flow paths 16, to be radially discharged by centrifugal force that is produced by rotation of the rotor 40, so that the first claw magnetic pole portions 42c and the second magnetic claw pole portions 43c can be directly cooled by the liquid coolant. As a result, efficient cooling can be performed, so that an excellent cooling effect can be achieved.

### Third Embodiment

The rotary electric machine of the third embodiment differs from the rotary electric machine 1 of the first embodiment in that the stator coil 21 including phase windings of 6 phases is used, though the stator coil 21 including the phase windings of 3 phases is used for the rotary electric machine 1 of the first embodiment. Hence, detailed descriptions of members and configurations common to the first embodiment are omitted in the following, with points of difference and important points being described referring to FIGS. 3 to 8 and 25. Members that are common to those of the first embodiment are designated by identical reference symbols to those of the first embodiment.

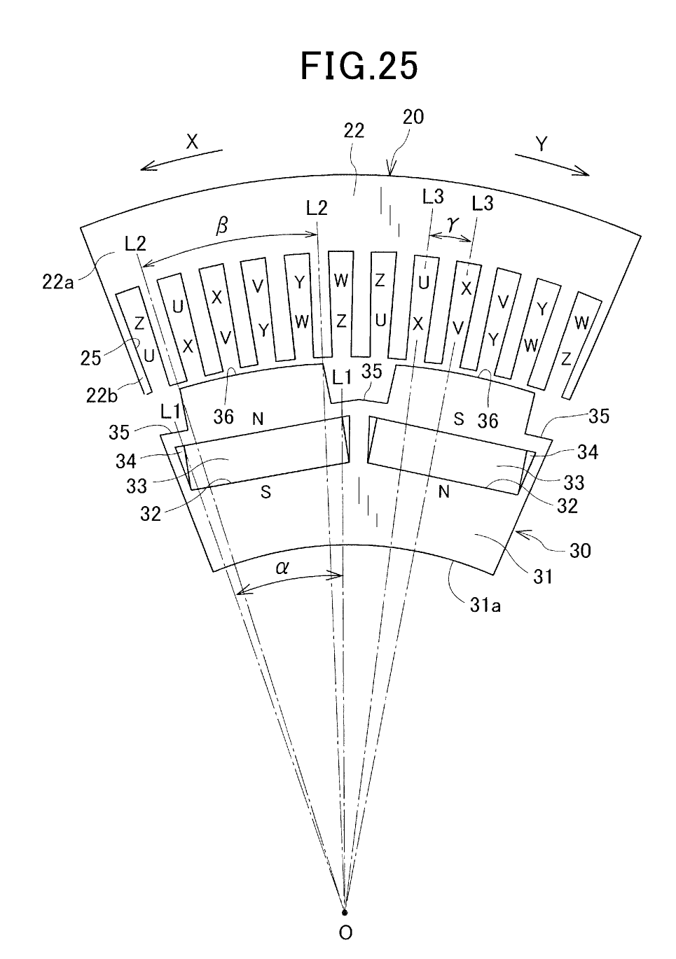

The stator coil 21 of the third embodiment, which has phase windings of 6 phases, is formed using pairs of large and small conductor segments 23 (large segment 231, small segment 232) shown in FIG. 4, as in the first embodiment. In this case, a pair of large and small conductor segments 231, 232 are inserted from one axial-direction end side (upper side of FIG. 4, the back-to-front direction of the paper of FIG. 25) of two slots 25A, 25C (see FIG. 8) which are separated by 5 slot pitches.

That is, one linear portion 23g1 of the large segment 231 is inserted into the fourth layer (outermost layer) of one slot 25A, while the other linear portion 23g2 is inserted into the first layer (innermost layer) of another slot (not shown) which is separated from slot 25A by 5 slot pitches in the counterclockwise direction of the stator core 22 (the Y arrow direction in FIGS. 4 and 25). One linear portion 23g3 of the small segment 232 is inserted into the third layer of one slot 25A, while the other linear portion 23g4 of the small segment 232 is inserted into the second layer of another slot (not shown) which is separated by 5 slot pitches in the counterclockwise direction of the stator core 22. The linear portions 23g of an even number of conductor segments 23 are arranged in that way and inserted into all of the slots 25. In the third embodiment, a total of 4 linear portions 23g1 to 23g4 are arranged radially in a single row in each slot 25 (see FIG. 6, FIG. 8).

In this case, one electrical conductor (slot-housed portion 23a) within each slot 25 is paired with one electrical conductor (slot-housed portion 23a) within another slot 25 that is separated by five slot pitches. For example, as shown in FIG. 8, an electrical conductor 213a that is housed in the first layer in one slot 25A is paired with an electrical conductor 213b that is housed in the fourth layer in another slot 25C which is separated by 5 slot pitches in the clockwise direction around the stator core 22 (X arrow direction in FIGS. 4, 5, 8, and 25). Similarly, an electrical conductor 232a that is housed in the second layer in one slot 25A is paired with an electrical conductor 232b that is housed in the third layer in another slot 25C which is separated by 5 slot pitches in the clockwise direction (X-arrow direction) around the stator core 22.

Similarly to the first embodiment, the open end portions of the paired linear portions (23g1, 23g2) (23g3, 23g4) of the large and small segments 231, 232, i.e. open end portions which extend from one axial-direction end of respective slots 25, are twisted in mutually opposite circumferential directions, forming oblique portions 23e having a length equal to approximately 2.5 slot pitches. The tip of the oblique portion 23e is formed integrally with a joint end portion 23f by bending deformation. Thereafter, at the axial-direction other end side of the stator core 22, predetermined paired joint end portions 23f of the conductor segments 23 are joined by welding or the like and electrically connected in a predetermined pattern.

In this way, by connecting specific conductor segments 23 in series, the stator coil 21 is formed which includes 6 phase windings (U-phase, V-phase, W-phase, X-phase, Y-phase, Z-phase) that are wave-wound circumferentially along the slots 25 of the stator core 22. In this case, each phase winding of the stator coil 21 is wound with short windings of 5 slot pitches, over n adjacent slots 25 (2 slots in the third embodiment, where n=2).

That is, in each phase winding, as shown in FIG. 25, two electrical conductors housed at the inner circumferential side in the slot 25 (in the first layer and in the second layer) are connected to two electrical conductors that are housed (in the third layer and in the fourth layer) at the outer circumferential side in the slot 25 that is separated by 5 slot pitches in the clockwise direction (X direction indicated by the arrow) of the stator core 22. Thus, in the third embodiment, the slot multiple n is 2, and hence, the slots 25 that house phase windings of the same phase in the first layer and the second layer at the inner circumferential side and also in the third layer and fourth layer at the outer circumferential side successively differ in circumferential position by one slot pitch.

Specifically as shown in FIG. 25, at the inner circumferential side at which the first layer and the second layer are housed, the slots 25 that respectively house the U-phase, X-phase, V-phase, Y-phase W-phase, and Z-phase windings are arranged so as to occur one at a time in repeated sequence, in the counterclockwise direction (Y-arrow direction) of the stator core 22. In addition, at the outer circumferential side at which the third layer and the fourth layer are housed, the slots 25 that respectively house the U-phase, X-phase, V-phase, Y-phase W-phase, and Z-phase windings are arranged so as to occur one at a time in repeated sequence, in the counterclockwise direction (Y-arrow direction) of the stator core 22 in the state of one slot pitch displacement. As a result, each of the phase windings is wound over n adjacent slots 25 (2 slots, when n=2) of the stator core 22.

It is noted that in the stator coil 21 of the third embodiment, as in the case of the first embodiment, due to the conductor segments 23 having a basically U-shaped form, each of the phase windings turns four times around the circumference of the stator core 22, and is formed with irregular segments (not shown in the drawings) having a different shape from that of the basic conductor segment 23. The irregular segments are segments that are integrally formed with output power lead-out wires or with neutral point lead-out wires, and segments having turn portions for respectively connecting the first and second circumferential turns, for connecting the second and third circumferential turns, and for connecting the third and fourth circumferential turns. The phase windings of the stator coil 21 are wired with star-formation wiring by using these irregular segments.

In the third embodiment, with the axis of rotation (O) of the rotor 30 as center, designating the arc ratio of the magnetic pole as α, the circumferential angular range of the magnetic flux interchange face 36 as β, and the slot pitch as γ, as in the first embodiment, the relationships β≦(3n−1)γ and β<α are satisfied. That is, due to the relationship β<α, it is ensured that when magnetic flux flows between the stator 20 and the rotor 30, the amount of magnetic flux within the range of the arc ratio α of the magnetic pole is greater than the magnetic flux that is set by the circumferential angular range β of a magnetic flux interchange face 36.

In addition, from the relationship β≦(3n−1)γ, the circumferential angular range β of the magnetic flux interchange face 36 is set as β≦(3×2−1)×3.75°=18.75°, being set as a range not exceeding 5 slot pitches of the inner periphery surface of the stator core 22. That is, the circumferential angular range β of the magnetic flux interchange face 36 is set so as to be equal to or less than the distance (5 slot pitches) between the two slots 25 housing electrical conductors (slot-housed portions 23a) of phase windings of the same phase, in which currents flow in mutually opposite directions. As a result, it is ensured that demagnetizing fields will not be produced by the phase windings of the same phase.

As described above, according to the rotary electric machine of the third embodiment, the slot multiple is set as n, each phase winding of the stator coil 21 is wound with short windings over n adjacent slots 25, and with the axis of rotation (O) of the rotor being the center, designating the arc ratio of the magnetic pole as α, the circumferential angular range of the magnetic flux interchange face 36 being β, and the slot pitch as γ, and the relationships β≦(3n−1)γ and β<α are satisfied. As a result, as in the case of the first embodiment, when magnetic flux flows between the stator 20 and the rotor 30, it is ensured that demagnetizing fields are not produced by the phase windings of the same phase of the stator core 21, so that a flow of magnetic flux between the stator 20 and the rotor 30 can be efficiently acquired.

In particular, in the case of the third embodiment, the upper limit of the circumferential angular range β of the magnetic flux interchange face 36 is increased to 5 slot pitches from the 4 slot pitches of the first embodiment, so that the amount of magnetic flux flowing through the magnetic flux interchange face 36 can be increased, thereby improving the performance.

### Eleventh Modification

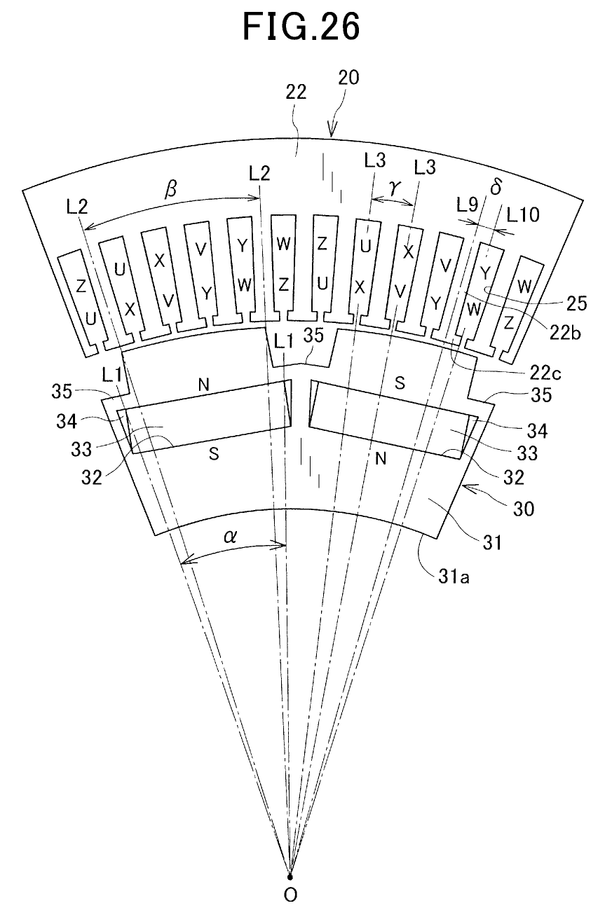

As shown in FIG. 26, as in the case of the seventh and eighth modifications, the stator core 22 of the eleventh modification differs from the stator core 22 of the third embodiment in that, in the eleventh modification, the tip of each of the teeth 22b formed at the inner periphery of the stator core 22 has flange portions 22c which project to the circumferentially-opposed sides from the projecting tip of the tooth. In this case, when designating δ as the circumferential angular range, whose center is the axis of rotation O of the rotor 30, between the circumferential-direction center of the tooth 22b and the circumferential-direction tip of the flange portion 22c of the tooth 22b, the circumferential angular range β of the magnetic flux interchange face 36 is set as β≦(3n−1)γ−2δ. It is noted that the circumferential angular range δ is defined by the angle between a straight line L9 connecting the axis of rotation O and the circumferential-direction center of the tooth 22b and a straight line L10 connecting the axis of rotation O and a circumferential-direction tip of the flange portion 22c.

When each tooth 22b has the flange portions 22c at the projected tip, as in the eleventh modification, the flow of magnetic flux between the stator 20 and the rotor 30 can be efficiently acquired by setting the circumferential angular range β of the magnetic flux interchange face 36 as the above-described range.

### Fourth Embodiment

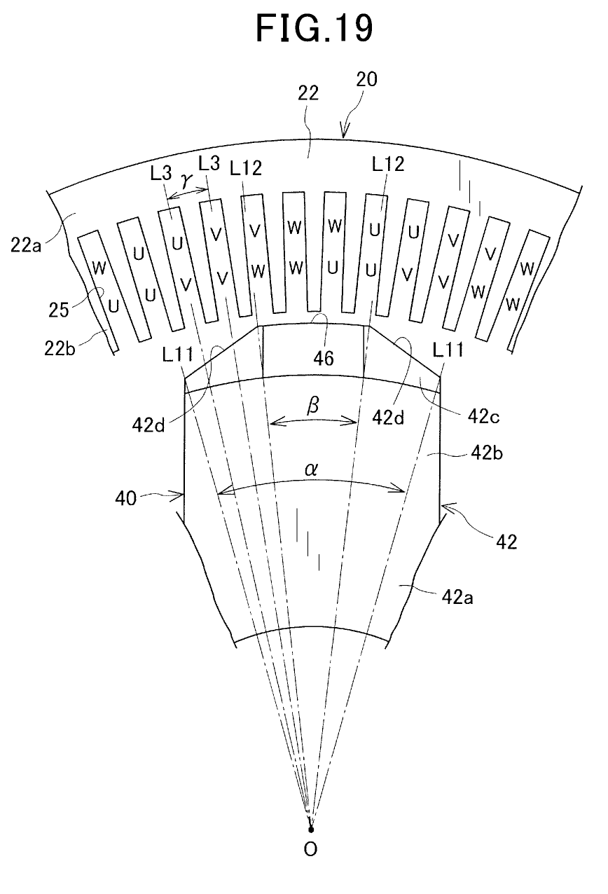

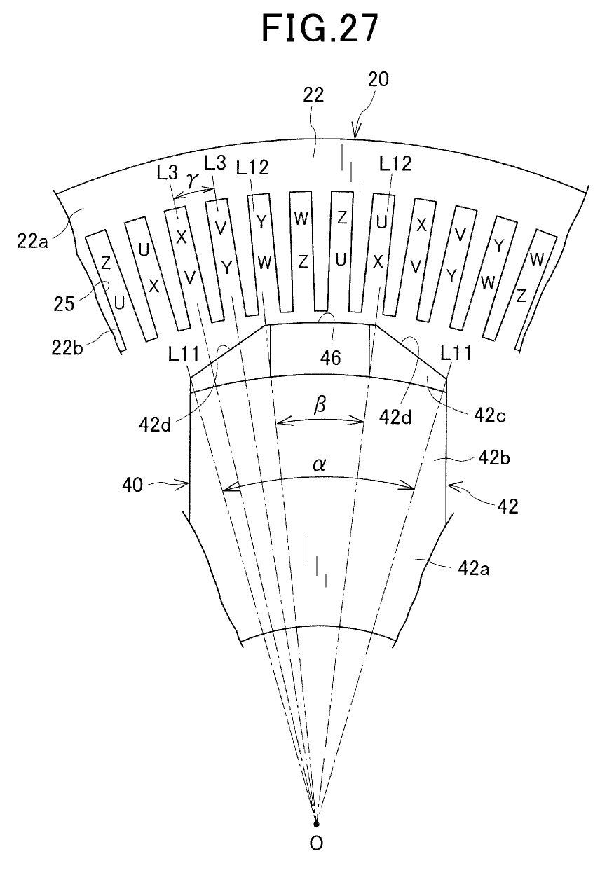

The rotary electric machine of the fourth embodiment differs from the rotary electric machine of the third embodiment, which uses the embedded permanent magnet type rotor 30, in that the electromagnet type rotor 40 having the Randle-type core 41 and the field coil 44 is used. That is, the rotary electric machine of the fourth embodiment, as shown in FIG. 27, is configured by assembling the stator 20 (see FIG. 25) having the stator coil 21 formed of phase windings of 6 phases of the third embodiment, and the rotor 40 (see FIG. 19) having the Randle-type core 41 and the field coil 44 of the second embodiment. Hence, members in FIG. 27 that are common to the second or third embodiments are designated by the same reference symbols, and detailed descriptions of the configurations and the like of the rotary electric machine of the fourth embodiment are omitted.

As described above, according to the rotary electric machine of the fourth embodiment, the slot multiple is set as n, each phase winding of the stator coil 21 is wound with short windings over n adjacent slots 25, and with the axis of rotation (O) of the rotor being the center, designating the arc ratio of the first and second claw magnetic pole portions 42c, 43c as α, the circumferential angular range of the magnetic flux interchange face 36 being β, and the slot pitch as γ, the relationships β≦(3n−1)γ and β<α are satisfied, and the maximum angle of the arc ratio α, αmax, is set as αmax≧3nγ. As a result, the same actions and effects as those of the rotary electric machine of the third embodiment can be obtained.

### Twelfth Modification

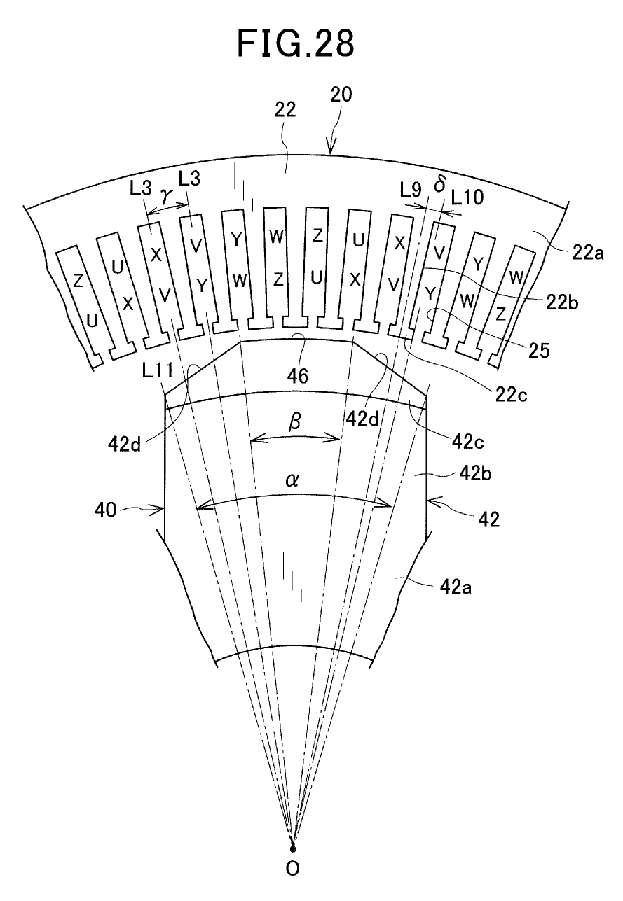

As shown in FIG. 28, as in the case of the seventh, eighth, and eleventh modifications, the stator core 22 of the twelfth modification differs from the stator core 22 of the fourth embodiment in that, in the twelfth modification, the tip of each of the teeth 22b formed at the inner periphery of the stator core 22 has flange portions 22c which project to the circumferentially-opposed sides from the projecting tip of the tooth. In this case, when designating δ as the circumferential angular range, whose center is the axis of rotation O of the rotor 30, between the circumferential-direction center of the tooth 22b and the circumferential-direction tip of the flange portion 22c of the tooth 22b, the circumferential angular range β of the magnetic flux interchange face 46 is set as β≦(3n−1)γ−2δ. It is noted that the circumferential angular range δ is defined by the angle between a straight line L9 connecting the axis of rotation O and the circumferential-direction center of the tooth 22b and a straight line L10 connecting the axis of rotation O and a circumferential-direction tip of the flange portion 22c.

When each tooth 22b has the flange portions 22c at the projected tip, as in the twelfth modification, the flow of magnetic flux between the stator 20 and the rotor 40 can be efficiently acquired by setting the circumferential angular range β of the magnetic flux interchange face 46 as the above-described range.

### Other Embodiments

The present invention is not limited to the above embodiments, and various changes are possible, without departing from the scope of the present invention.

For example, in the first to fourth embodiments described above, examples are described in which a rotary electric machine according to the present invention is applied to a motor generator for a vehicle. However, the present invention may be applied to a rotary electric machine which is installed in a vehicle and functions simply as a generator or as a motor.

### REFERENCE SIGNS LIST

1, 2 . . . rotary electric machine, 13 . . . shaft, 15 . . . first flow path, 16 . . . second flow path, 20 . . . stator, 21 . . . stator coil, 22 . . . stator core, 22b . . . tooth, 22c . . . flange portion, 25 . . . slot, 30 . . . rotor, 31 . . . rotor core, 32, 32a, 32b, 32c, 32d, 32e . . . magnet housing portion, 33, 33a, 33b, 33c, 33d, 33e, 33f . . . permanent magnet, 35 . . . recess, 36 . . . magnetic flux interchange face, 37 . . . chamfer, 40 . . . rotor, 41 . . . Randle-type core, 42 . . . first pole core, 42c . . . first claw magnetic pole portion, 43 . . . second pole core, 43c . . . second claw magnetic pole portion, 44 . . . field coil, 46 . . . magnetic flux interchange face, O . . . axis of rotation of rotor

1-15. (canceled)

16. A rotary electric machine comprising:
a rotor which has a plurality of magnetic poles arranged with polarities that alternate in a circumferential direction, and
a stator which has a stator core having a plurality of slots circumferentially arranged and radially facing the rotor, and which has a stator coil housed in the slots and formed of phase windings of three phases that are wound as distributed windings in the stator core, wherein
a slot multiple of the slots in the stator core is set as n, with a proportion of n slots per one phase of the stator coil (where n is a natural number of 2 or more),
each of the phase windings of the stator coil is wound as a short winding extending over (n+1) adjacent ones of the slots,
the rotor includes a Randle-type core and a field coil, the Randle-type core including a combination of a first pole core having first claw magnetic pole portions and a second pole core having second claw magnetic pole portions, with the first claw magnetic pole portions and the second claw magnetic pole portions being arranged to alternate in the circumferential direction, and the field coil being wound in the Randle-type core,
with an axis of rotation of the rotor as center, designating α as an arc ratio of the first and second claw magnetic pole portions, β as a circumferential-direction angular range of each magnetic flux interchange face of the first and second claw magnetic pole portions, which is positioned so as to face the stator core and at which magnetic flux is interchanged with the stator core, and γ as a slot pitch of the slots in the circumferential direction, relationships β≦2nγ and β<α are established and
the first and second claw magnetic pole portions are formed such that the arc ratio α varies along an axial direction, and designating a maximum value of the arc ratio α as αmax, a relationship αmax≧3nγ is established.

17. The rotary electric machine according to claim 16, wherein the circumferential angular range β of the magnetic flux interchange faces of the first and second claw magnetic pole portions gradually becomes smaller from axial-direction base sides of the first and second claw magnetic pole portions to tip sides of the first and second claw magnetic pole portions.

18. The rotary electric machine according to claim 16, wherein the rotor has a first flow path, through which a liquid coolant flows in the axial direction, in a shaft.

19. The rotary electric machine according to claim 18, wherein the shaft and the Randle-type core have a second flow path which communicates with the first flow path, and through which the liquid coolant flows in a radial direction.

20. The rotary electric machine according to claim 16, wherein
the stator core has a plurality of teeth projecting radially and partitioning the slots arranged in the circumferential direction, with flange portions projecting from tip portions of the teeth to circumferentially opposing sides, and
designating δ as a circumferential angular range, whose center is the axis of rotation of the rotor, from a circumferential-direction center of the tooth to a circumferential-direction tip of the flange portion, a relationship β≦2nγ−2δ is established for the circumferential-direction angular range β of the magnetic flux interchange face.

21. A rotary electric machine comprising:
a rotor which has a plurality of magnetic poles arranged with polarities that alternate in a circumferential direction, and
a stator which has a stator core having a plurality of slots circumferentially arranged and radially facing the rotor, and which has a stator coil housed in the slots and formed of phase windings of six phases that are wound as distributed windings in the stator core, wherein
a slot multiple of the slots in the stator core is set as n, with a proportion of n slots per one phase of the stator coil (where n is a natural number of 2 or more),
each of the phase windings of the stator coil is wound as a short winding extending over n adjacent ones of the slots,
the rotor includes a Randle-type core and a field coil, the Randle-type core including a combination of a first pole core having first claw magnetic pole portions and a second pole core having second claw magnetic pole portions, with the first claw magnetic pole portions and the second claw magnetic pole portions being arranged to alternate in the circumferential direction, and the field coil being wound in the Randle-type core,
with an axis of rotation of the rotor as center, designating α as an arc ratio of the first and second claw magnetic pole portions, β as a circumferential-direction angular range of each magnetic flux interchange face of the first and second claw magnetic pole portions, which is positioned so as to face the stator core and at which magnetic flux is interchanged with the stator core, and γ as a slot pitch of the slots in the circumferential direction, relationships β≦(3n−1)γ and β<α are established, and
the first and second claw magnetic pole portions are formed such that the arc ratio α varies along an axial direction, and designating a maximum value of the arc ratio α as αmax, a relationship αmax≧3nγ is established.

22. The rotary electric machine according to claim 21, wherein
the stator core has a plurality of teeth projecting radially and partitioning the slots arranged in the circumferential direction, with flange portions projecting from tip portions of the teeth to circumferentially opposing sides, and
designating δ as a circumferential angular range, whose center is the axis of rotation of the rotor, from a circumferential-direction center of the tooth to a circumferential-direction tip of the flange portion, a relationship β≦(3n−1)γ−2δ is established for the circumferential-direction angular range β of the magnetic flux interchange face.
